(19) United States
(12) Patent Application Publication
(10) Pub. No.: US 2016/0253769 A1
(43) Pub. Date: Sep. 1, 2016

(54) Method of preserving secrecy during source code comparison

(71) Applicant: Don Waldhalm, Bradenton, FL (US)

(72) Inventor: Don Waldhalm, Bradenton, FL (US)

(21) Appl. No.: 14/631,979

(22) Filed: Feb. 26, 2015

(51) Int. Cl. G06Q 50/18; G06F 21/12

(52) U.S. Cl. CPC G06Q 50/184; G06F 21/125

(57) ABSTRACT

A method of comparing sets of computer source code for the sake of litigation support is disclosed, in which an expert witness utilizes automated comparison techniques and leverages indexed copies of underlying sets to obfuscate design and implementation details, while preserving the integrity of the source code comparison.

### FIELD OF THE INVENTION

The field of the invention is source code comparison for Intellectual Property litigation.

The present invention relates to the protection of secrecy of Intellectual Property during litigation and in particular to the Discovery phase of litigation in cases involving software Intellectual Property and the related source code artifacts.

The invention preserves the quality of discovery in cases where discovery would otherwise be severely limited in the interest of preserving secrecy.

### BACKGROUND OF THE INVENTION

Intellectual Property (IP) cases involving computer source code comparison require the employment of software comparison experts. These experts generally employ automated comparison techniques to establish the similarities between two sets of source code. These automated techniques are invaluable in helping the expert describe the types and scale of similarities between set of source. Furthermore, the automated comparison helps the expert prioritize subsequent, manual examination efforts. Because software sets often contain huge numbers of files, the automated processes are crucial to obtain reliable results. Unfortunately, the low-trust environment inherent in IP disputes often leads to negotiated review restrictions that make the application of automated comparison impossible. For example, typical terms of a review may include that the examiner may only review a party's data on the party's premises. The examiner may not copy any data from a particular computer purpose built for the examination. The examiner may not communicate with anyone outside the review facility (no Internet or phone access). Any devices and/or data brought to the exam or produced during the exam is subject to collection, review and redaction by opposing party. Typically, the level of exposure deemed unacceptable is so small that even if a comparison can be implemented, the results are redacted to the point that they are useless. For example, opposing party may redact every file name and directory path that pertains to their software. This type of redaction renders file pairs (a common form of comparison results) meaningless. Without meaningful file pairs, the examiner is unable to communicate the general similarity of the code sets to his client and to the court. Furthermore, the examiner is unable to call on specific file pairs for further manual analysis or to create exemplars for the court. As a result, cases are prosecuted with incomplete, inaccurate and unreliable information. These ill-informed cases cost more money and take more time than they otherwise would-which harms both involved parties and the general public, who together pay the cost.

What is needed is a method for an examiner to perform and communicate the results of a complete, comparison including mechanisms for identifying and requesting particular files for further manual analysis, while preserving the secrecy of the design and implementation of each compared set of source code.

The things that are needed will be put forth as solutions in the next section.

### OBJECTS OF THE INVENTION

It is an object of this invention to provide a method for an expert to deploy typical automated comparison tools without modification. It is another object of this invention to protect the secrecy of each party's source code from unauthorized exposure. It is yet another object of this invention to generate comparison results that are both complete and useful, and will not be redacted for exposing design and implementation details of either underlying set. It is yet another object of this invention to generate comparison results sufficient for the examiner to identify particular files in either set.

Still other objects and advantages of the invention will in part be obvious and will in part be apparent from the specification and code listings.

### SUMMARY OF THE INVENTION

In order to overcome the restrictive review environment an encrypted copy of one code set is brought to the review of the other and left on premises with opposing party when the review is complete. Leaving the device with opposing party ensures that no data is extracted from the review. Encryption ensures that no data is exposed to opposing party.

In order to overcome the restrictions on result communication indexes of the two file directories to be examined are generated. A complete index including an id, directory path and file names and a file hash is generated for each party's source code. Each party has a complete index of their own set. Each party has an incomplete index (containing only id and hash) of the opposing party's set. Comparison results are calculated and communicated in terms of the indexed id. Thus, functionally complete comparison information is freely shared between parties without divulging details of directory structure and file names.

To provide unrestricted use of comparison tools, working directories to represent each compared set are generated. The working directories are flattened so that no original directory structure of the original set is preserved. Furthermore, the file names in the working directory are generated according to the id values from the aforementioned indexes. This allows typical comparison tools (which are built to operate on file directories) to operate as usual, yet produce obfuscated result in which no file names or directory paths are divulged.

To enable the examiner to identify and manually examine particular file pairs after the initial comparison is complete, comparison results are communicated in terms of the id values of the indexes. The index hashes provide a mechanism for the examiner to ensure that the correct file has been collected for further analysis.

The invention accordingly comprises the several steps and the relation of one or more of such steps with respect to each of the others. All is exemplified in the following detailed disclosure, and the scope of the invention will be indicated in the claims.

### DETAILED DESCRIPTION OF THE PREFERRED EMBODIMENTS

Description of the preferred embodiment requires definition of the following terms.
Client set One of the sets of source code to be compared. It is available to the examiner without restriction, but must not be exposed to the opposition.
Opposition set One of the sets of source code to be compared. This set belongs to the opposition. It is only available to the examiner during the comparison, and under the negotiated terms of the review. It may not be copied, and may not be removed from the examination room.
Lab The examiner's lab. An environment in which the examiner is free of time restrictions. The Client set is continuously available in the Lab. The Opposition set is not available in the Lab.
Examination room The physical environment specified for the comparison. This is the only environment in which the examiner has access to the Opposition set. When in the examination room, examiner has no access to information or tools outside the examination room. The examiner has a finite amount of time to access the examination room. Any data brought into the examination room, or created in the examination room is to be collected, reviewed and redacted by the opposition.
Encrypted device A portable media storage device, on which device-level encryption is implemented. Only the examiner has the key for deciphering the device. This embodiment uses a USB drive encrypted with LUKS.
Bootable device a portable media storage device containing a boot sector and an operating system. This embodiment uses a USB drive with an instance of Arch Linux.
Indexed File An indexed file is a record representing one file from one of the sets of source code to be examined. The record contains the following fields: Id, Hash and Path. The Id field is the index key, and is unique in the given set. The hash is an MD5 hash of the file data which the record represents. The path is the full file path (including the file name) of the file that the record represents.
Informed index An informed index is a list of Indexed Files containing one record for each file in a give set.
Obfuscated index An obfuscated index is an informed index from which the path field has been removed.
Indexed copy An indexed copy is a copy of a given set of source code, in which both the directory structure and file names have been removed. An indexed copy is created by leveraging the informed index to identify each file in a given set. Each file is copied to a new file in the target directory of the copy. The new file is named with the Id value from the indexed file. Thus the target directory contains an indexed copy of the given set, in which there is only one directory, and the file names have been replaced with Id values from the informed index.
Indexed link copy An indexed link copy is a representation of a given set of source, in which both directory structure and file names have been removed. It is created by leveraging the informed index to identify each file in a given set. A symbolic link is created in the target directory fore each indexed file in the informed index. The link's target is the path value of the indexed file, and the link's name is the Id value of the indexed file.
Examination Machine Is the computer provided to the examiner in the examination room. It contains the opposition set.

The method is executed in two phases. The first phase is preparation. The second phase is examination.

During preparation, an informed index of the client set is created and stored in the Lab. An informed copy of the client set is created on the encrypted device. Comparison software is copied to the encrypted device.

During the examination phase, the encrypted device is taken to the examination room, and connected to the examination machine. The examination machine is either booted to the encrypted device (in this embodiment the encrypted device and the bootable device are one in the same), or the machine is booted with its own operating system, and the encrypted device is mounted. An informed index of the opposition set is created and stored on the examination machine. An indexed link copy of the opposition set is created on the encrypted device. The comparison software which was stored on the bootable device is executed to compare the client indexed copy to the opposition index link copy. Depending on the comparison software, intermediate results (such as databases of source elements) may be generated. Any intermediate results of the comparison routines are stored on the encrypted device. Final results of the comparison routines are stored on the examination machine. The encrypted device is disconnected from the examination machine.

### Encrypted Bootable Device

The following outlines the steps necessary to create an encrypted, bootable device—specifically, an encrypted USB flash drive with an instance of Arch Linux. Other media, operating systems, and encryption strategies would suffice.

Wipe the USB drive:
sudo dd if=/dev/urandom of=/dev/sdd bs=1M

Format the USB with a boot sector and a data sector:

```
sudo gdisk /dev/sdd
o
    y
n
    <enter>
    <enter>
    +100M
    EF00
n
    <enter>
    <enter>
    <enter>
    <enter>
w
```

Encrypt root sector:

Encrypt the root sector with dm-crypt and LUKS.
sudo cryptsetup -v luksFormat /dev/sdd2
   Unlock the encrypted sector. The following will make it accessible as/dev/mapper/root:
sudo cryptsetup --type luks open/dev/sdd2 root

Create File Systems:

Create a FAT32 boot sector, and an ext4 file system on the main partition, without journaling.
sudo mkfs. vfat -F 32 /dev/sdd1
sudo mkfs. ext4 -O“̂has_journal” /dev/mapper/root

Mount the partitions:

Moun the main partition to “/mnt” and the boot partition to “/mnt/boot”
sudo mount /dev/mapper/root /mnt
sudo mkdir /mnt/boot
sudo mount /dev/sdd1 /mnt/boot

Install and configure the new system:

Install the base packages.
sudo pacstrap /mnt base

Configure the system to use UUID disk identifiers so the boot loader doesn't fail later when the USB is used on another system, and the drives are renamed. Generate the fstab file.
sudo touch /mnt/etc/fstab
sudo chmod a+w /mnt/etc/fstab
genfstab -p -U /mnt >> /mnt/etc/fstab

Change Root to the new environment.
sudo arch-chroot /mnt

Install packages on the portable OS (these are examples). Vim is a file editor. NTFS-3g enables the mounting of ntfs-formated drives.
pacman -S vim
pacman -S ntfs -3g

Edit the/etc/mkinitcpio.conf file so that the proper hooks and modules are installed.

HOOKS=“base udev block keymap keyboard encrypt filesystems”
MODULES=“nls-cp437 vfat hid_generic usbhid ext4”

Run configuration script.

mkinitcpio -p linux

Install the Syslinux bootloader:

The syslinux bootloader has an automatic configuration script that will support bion. Install the bootloader package, and the packages that its automated configuration scripts will need.

pacman -S syslinux
pacman -S gptfdisk
pacman -S mtools

Edit the resulting syslinux.cfg file so that it uses the UUID of the usb disk. Also, add crypt kernel parameters so that the/partition can be decrypted during boot.

Edit/boot/syslinux/syslinux.cfg:

The initial entry will look something like this:

```
...
LABEL arch
    MENU LABEL Arch Linux
    LINUX ../vmlinuz-linux
    APPEND root=/dev/sda3 rw
    INITRD ../initramfs-linux.img
...
```

Change it so that it looks like this:

```
...
LABEL arch
    MENU LABEL Arch Linux
    LINUX ../vmlinuz-linux
    APPEND cryptdevice=UUID=d51cc2a8-26a7-417a-8615-
    11cbc05d5c33:root
        root=/dev/mapper/root
    INITRD ../initramfs-linux.img
...
```

Run the automated configuration script.

syslinux-install_update -i -a -m

### Source Code Listings

Code listings 1, 2, 3, 4, and 5 compile as described in code listing 6 to an executable called “indexer” that offers “copy” and “link” commands functions—which implement the described method of creating an indexed copy and an indexed linked copy respectively.

Listing 1: indexer.h

```
#ifndef _indexer_cs_h_{—}
#define _indexer_cs_h_{—}
#include <string>
#include <vector>
struct IndexedFile
{
    int id;
    std::string hash;
    std::string path;
    std::string InformedString( ) const;
    std::string ObfuscatedString( ) const;
};
namespace FileSystem {
    void recursive_file_list(std::string directory, std::
        vector<std::string> * files);
    void link(const IndexedFile & indexed_file, const std::
        string & target);
    void copy(const IndexedFile & indexed_file, const std::
        string & target);
    void append_informed_index(const IndexedFile &
        indexed_file, const std::string & target_directory);
    void append_obfuscated_index(const IndexedFile &
        indexed_file, const std::string & target_directory);
}
namespace LocalSystem{
    std::string call_external(const std::string & command);
    std::string & trim(std::string & str);
}
class Indexer
{
    std::vector<IndexedFile> index;
    public:
    Indexer(const std::string & directory_path);
    std::vector<IndexedFile> get_index( ) const;
    void copy(const std::string & target);
    void link(const std::string & target);
};
#endif
```

Listing 2: main.cpp

```
#include <iostream>
#include “indexer.h”
void usage( ){
    using std::cout;
    using std::endl;
    cout<< “usage:” << endl;
    cout << “indexer copy <directory_to_index><
        target_directory>” << endl;
    cout << “ creates a copy of each file in the
        directory_to_index along with both an informed index
        and an obfuscated index” << endl;
    cout << “indexer link <directory_to_index><
        target_directory>” << endl;
    cout << “ creates a symbolic link of each file in the
        directory_to_index along with both an informed index
        and an obfuscated index” << endl;
    cout << endl;
}
int main(int argc, char** argv){
    using std::string;
    if (argc != 4){
        usage( );
        return 1; //usage error
    }
    string cmd = string{argv[1]};
    string source = string{argv[2]};
    string target = string{argv[3]};
    Indexer indexer(source);
    if(cmd == “copy”){
        indexer.copy( target );
    }
    else if(cmd == “link”){
        indexer.link( target );
    }
    else{
        usage( );
    }
}
```

Listing 3: indexer.cpp

```
#include <vector>
#include <iostream>
#include <sstream>
#include “indexer.h”
Indexer::Indexer(const std::string & directory_path)
{
    using std::vector;
    using std::string;
    //recursively get files in the directory
    vector<string> files;
    FileSystem::recursive_file_list(directory_path, &files);
    //create an IndexedFile object for each file
    vector<IndexedFile> indexed_files;
    for (int i = 0; i < files.size( ); i++) {
        //hash the file
        std::stringstream hash_command;
        hash_command << “md5sum ” << files[i].c_str( ) << “ |
            awk {’print $1’}”;
        std::string hash = LocalSystem::call_external(
            hash_command.str( ));
        //create the IndexdFile object
        IndexedFile indexed_file = IndexedFile
        {
            i,
            hash,
            files[i]
        };
        //add it to the vector
        indexed_files.push_back(indexed_file);
    }
    //set the indexed files vector
    index = indexed_files;
}
std::vector<IndexedFile> Indexer::get_index( ) const
{
    return index;
}
void Indexer::copy( const std::string & target)
{
    for (int i = 0; i < index.size( ); i++) {
        IndexedFile f = index[i];
        FileSystem::copy(f, target);
        FileSystem::append_informed_index(f, target);
        FileSystem::append_obfuscated_index(f, target);
    }
}
void Indexer::link(const std::string & target)
{
    for (int i = 0; i < index.size( ); i++) {
        IndexedFile f = index[i];
        FileSystem::link(f, target);
        FileSystem::append_informed_index(f, target);
        FileSystem::append_obfuscated_index(f, target);
    }
}
```

Listing 4: indexed_file.cpp

```
#include “indexer.h”
#include <string>
#include <sstream>
std::string IndexedFile::InformedString( ) const
{
    std::ostringstream stm ;
    stm << “id: ” << id << “ hash: ” << hash << “ path: ” <<
        path;
    return stm.str( ) ;
}
std::string IndexedFile::ObfuscatedString( ) const
{
    std::ostringstream stm ;
    stm << “ id: ” << id << “ hash: ” << hash;
    return stm.str( ) ;
}
```

Listing 5: util.cpp

```
#include “indexer.h”
#include <string>
#include <sstream>
#include <stdio.h>
#include <dirent.h>
#include <limits>
#include <algorithm>
#include <iostream>
void FileSystem::link(const IndexedFile & indexed_file, const
    std::string & target)
{
    IndexedFile f = indexed_file;
    //link to the target
    std::stringstream link_string;
    link_string << “ln -s ” << f.path << “ ” << target << “/”
        << f.id;
    system(link_string.str( ).c_str( ));
}
void FileSystem::copy(const IndexedFile & indexed_file, const
    std::string & target)
{
    IndexedFile f = indexed_file;
    //copy to the target
    std::stringstream copy_string;
    copy_string << “cp ” << f.path << “ ” << target << “/” <<
        f.id;
    system(copy_string.str( ).c_str( ));
}
void FileSystem::append_informed_index(const IndexedFile &
    indexed_file, const std::string & target_directory)
{
    IndexedFile f = indexed_file;
    //append the informed index listing
    std::stringstream informed;
    informed << “echo ’” << f.InformedString( ).c_str( ) << “’
        >> ” << target_directory << “/informed.txt”;
    system(informed.str( ).c_str( ));
}
void FileSystem::append_obfuscated_index(const IndexedFile &
    indexed_file, const std::string & target_directory)
{
    IndexedFile f = indexed_file;
    //append the obfuscated index listing
    std::stringstream obfuscated;
    obfuscated << “echo ’” << f.ObfuscatedString( ).c_str( ) <<
        “’ >> ” << target_directory << “/obfuscated.txt”;
    system(obfuscated.str( ).c_str( ));
}
void FileSystem::recursive_file_list(std::string directory,
    std::vector<std::string> * files)
{
    DIR *dir;
    struct dirent *ent;
    if ((dir = opendir (directory.c_str( ))) != NULL) {
        while ((ent = readdir (dir)) != NULL) {
            if (ent->d_type == DT_REG) {
                files->push_back(directory + “/” + ent->
                    d_name);
            }
            if(ent->d_type == DT_DIR){
                std::string name = ent->d_name;
                if(name != “.” && name != “..”){
                    FileSystem::recursive_file_list(directory +
                        “/” + name, files);
                }
            }
        }
        closedir (dir);
    }
}
std::string & LocalSystem::trim(std::string & str)
{
    str.erase(str.begin( ), find_if(str.begin( ), str.end( ),
    [ ](char& ch)->bool { return !isspace(ch); }));
    str.erase(find_if(str.rbegin( ), str.rend( ),
    [ ](char& ch)->bool { return !isspace(ch); }).base( ), str.
        end( ));
    return str;
}
std::string LocalSystem::call_external(const std::string &
    command)
{
    using std::string;
    string return_string;
    FILE * stream;
    int buff_size = 4096;
    char buffer[buff_size];
    stream = popen(command.c_str( ), “r”);
    while ( fgets(buffer, buff_size, stream) != NULL )
        return_string.append(buffer);
    pclose(stream);
    return LocalSystem::trim(return_string);
}
```

Listing 6: CMakeLists.txt

```
SET(sources
    main.cpp
    indexer.cpp
    indexed_file.cpp
    util.cpp
    )
add_executable(indexer ${sources})
add_definitions(−std=c++11)
```

### Example

As an example, consider the following client set (listing 7) and opposition set (listing 8):

Listing 7: Client Set

ClientSet/codeFile1.txt
ClientSet/DirectoryA/codeFile2.cs
ClientSet/DirectoryA/codeFile3.cpp
ClientSet/DirectoryB/codeFile4.cs
ClientSet/DirectoryB/codeFile5.xml

Listing 8: Opposition Set

OppositionSet/ADir/fileOfCode1.txt
OppositionSet/BDir/fileOfCode2.cs
OppositionSet/BDir/fileOfCode3.xml
OppositionSet/BDir/fileOfCode4.cpp

An examiner using the invention would create an indexed copy of the ClientSet directory on the encrypted device (assuming that ClientIndexedCopy is a directory on the encrypted device) with the following command:
indexer copy ClientSet ClientIndexedCopy
   Resulting in the following ClientIndexedCopy directory:

Listing 9: CliendIndexedCopy Directory

ClientIndexedCopy/0
ClientIndexedCopy/1
ClientIndexedCopy/2
ClientIndexedCopy/3
ClientIndexedCopy/4
ClientIndexedCopy/informed.txt
ClientIndexedCopy/obfuscated.txt

The Informed index is as follows:

Listing 10: CliendIndexedCopy/informed.txt

```
id: 0 hash: 233d73b8b496a8ab7b78157481753b23 path: ClientSet/
    DirectoryB/codeFile5.xml
id: 1 hash: f2b060a639685aad0986f1df3decf575 path: ClientSet/
    DirectoryB/codeFile4.cs
id: 2 hash: 9f524ffcb22b726547bb40967083c57a path: ClientSet/
    DirectoryA/codeFile2.cs
id: 3 hash: f80fc6dd056d12ce86a3ec56b5de0283 path: ClientSet/
    DirectoryA/codeFile3.cpp
id: 4 hash: e10c3f82b21a52ca98241b844fcd3b1b path: ClientSet/
    codeFile1.txt
```

The obfuscated index is as follows:

Listing 11: CliendIndexedCopy/obfuscated.txt

id: 0 hash: 233d73b8b496a8ab7b78157481753b23
id: 1 hash: f2b060a639685aad0986f1df3decf575
id: 2 hash: 9f524ffcb22b726547bb40967083c57a
id: 3 hash: f80fc6dd056d12ce86a3ec56b5de0283
id: 4 hash: e10c3f82b21a52ca98241b844fcd3b1b

Next, the examiner would take the encrypted device to the examination room, and create an indexed linked copy of the Opposition Set with the following command (assuming that OppositionSet is a directory on the examination machine containing the opposition set, and that OppositionIndexedLink is a directory on the encrypted device):
indexer link OppositionSet OppositionIndexedLink
   Resulting in the following OppositionIndexedLink directory:

Listing 12: OppositionIndexedLink Directory

OppositionIndexedLink/0
OppositionIndexedLink/1
OppositionIndexedLink/2
OppositionIndexedLink/3
OppositionIndexedLink/informed.txt
OppositionIndexedLink/obfuscated.txt

The Informed index is as follows:

Listing 13: OppositionIndexedLink/informed.txt

```
id: 0 hash: d41d8cd98f00b204e9800998ecf8427e path:
    OppositionSet/BDir/fileOfCode4.cpp
id: 1 hash: d41d8cd98f00b204e9800998ecf8427e path:
    OppositionSet/BDir/fileOfCode3.xml
id: 2 hash: 42338525f7c098e4e14513692d91c83d path:
    OppositionSet/BDir/fileOfCode2.cs
id: 3 hash: 7d9823f0088fe2843ba18635f055bd6f path:
    OppositionSet/ADir/fileOfCode1.txt
```

The obfuscated index is as follows:

Listing 14: Oppositionindexedlink/obfuscated.txt

id: 0 hash: d41d8cd98f00b204e9800998ecf8427e
id: 1 hash: d41d8cd98f00b204e9800998ecf8427e
id: 2 hash: 42338525f7c098e4e14513692d91c83d
id: 3 hash: 7d9823f0088fe2843ba18635f055bd6f

Automated comparison routines may be executed against the CliendIndexedCopy and the OppositionIndexedLink directories. Results of the comparisons may be stored on the examination machine, so that the opposition parties may examine them.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying code listings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. A method for comparing two source code sets programmatically without exposing design or implementation details to external or opposing parties comprising:
a) building an encrypted portable storage device,
b) making an indexed copy of the client set on said device,
c) making an indexed link copy of the opposition set on said device,
d) executing comparison software against the two indexed sets,
e) disseminating comparison results in terms of the indexes,
f) disseminating obfuscated indexed listings to opposing parties.

2. The method of claim 1 wherein the encrypted portable device is bootable and contains comparison software to be executed against both sets.

3. The method of claim 1 wherein the encrypted portable device is not bootable and comparison software to be executed against both sets resides on other media.

4. The method of claim 1 wherein both sets are simultaneously available in the examination room, and an indexed link copy of the client set is made on the device instead of an indexed copy.

5. The method of claim 1 wherein neither set is available in the examination room and an indexed copy of each set is made on the device prior to the examination.
